(19) United States
(12) Patent Application Publication
(10) Pub. No.: US 2017/0142234 A1
(43) Pub. Date: May 18, 2017

(54) SCALABLE ADDRESSING MECHANISM FOR VIRTUAL MACHINES

(71) Applicant: Microsoft Technology Licensing, LLC, Redmond, WA (US)

(72) Inventors: Deepak Bansal, Sammamish, WA (US); Parag Sharma, Issaquah, WA (US)

(21) Appl. No.: 14/941,277

(22) Filed: Nov. 13, 2015

(51) Int. Cl. H04L 29/06; H04L 12/24

(52) U.S. Cl. CPC H04L 69/167; H04L 41/0803

(57) ABSTRACT

The use of physical addresses with virtual machines. A virtual machine is identified and assigned virtual and physical addresses. A data packet with a header including virtual addresses for the virtual machine and a destination virtual machine is sent from the virtual machine. An additional header including physical addresses associated with a large capacity addressing scope of the virtual machine and destination virtual machine is placed on the data packet at the virtual machine host. The data packet is sent from the host to a destination virtual machine host. Similarly, a data packet including headers with physical addresses associated with a large capacity addressing scope and virtual addresses for a destination and source virtual machine is received at the destination virtual machine's host. The header containing the physical addresses of the source and destination virtual machines is removed from the data packet and sent to the destination virtual machine.

### BACKGROUND

Computer systems and related technology affect many aspects of society. Indeed, the computer system's ability to process information has transformed the way we live and work. More recently, computer systems have been coupled to one another and to other electronic devices to form both wired and wireless computer networks. These computer systems and electronic devices can communicate with one another over the internet using the Internet Protocol (IP). The first major version of IP, and the one still most frequently used to route internet traffic today, is called IPv4.

IP has the principal task of routing and delivering data, known as packets, that are routed from source computer systems to destination computer systems based on IP addresses contained within packet headers. Thus, each device that connects to the internet must be assigned an IP address for communication and identification purposes. Under IPv4, 32-bit IP addresses are assigned to devices connected to the internet, meaning there are 2³² (or roughly 4.29 billion) available addresses to assign to devices. With the advent of smartphones, tablets, and virtual machines available through cloud computing providers, the number of devices connected to the internet, and thus necessitating IP addresses, is now beginning to exceed the number of available addresses under IPv4.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to assigning addresses to virtual machines. In some embodiments, a virtual machine is identified and assigned both a virtual address associated with a virtual network and a physical address. The physical address space is to be large to account for all the virtual machines belonging to all the customers that may exist in a cloud or a region of the cloud, and even perhaps in global virtual networks. By leveraging a scalable mechanism for assigning physical addresses, the virtual machines can communicate with each other seamlessly—otherwise the physical address space would have to be re-used thereby limiting the seamless connectivity amongst the virtual machines.

A data packet with a header that includes the virtual address of the virtual machine and a virtual address of a destination virtual machine is then sent from the virtual machine. An additional header that includes the physical address of the virtual machine and a physical address of the destination virtual machine is then placed on the data packet at a host of the virtual machine. The data packet is then sent from the host to a host of the destination virtual machine.

In other embodiments, a data packet that includes a header with physical addresses for both a destination virtual machine and a source virtual machine, as well as a header with a virtual address for both the destination and the source virtual machines, is received at a host of the destination virtual machine. The physical addresses for both the destination and source virtual machines are assigned using the scalable addressing mechanism that allows the physical addresses to be unique without including a machine-specific identifier that is persistently assigned to the virtual machine. The header containing the physical addresses of the source virtual machine and the destination virtual machine is then removed from the data packet and sent to the destination virtual machine.

In other embodiments, a physical address of a virtual machine that is structured to be interpretable by a computer system is created by the computer system. The physical address includes a first segment with a virtual address of the virtual machine, a second segment with an address of a host of the virtual machine, and a scalable address assigned by the scalable address mechanism and that allows the physical address to be unique without having to include in the physical address a machine-specific identifier persistently assigned to the virtual machine.

Some of the technical gain includes the ability to create global virtual networks with very large numbers of virtual machines. With IPv4 addresses, data centers in different regions of the world often share the same IPv4 addresses with other regions. However, utilizing the large addressing scope of IPv6 by assigning an IPv6 address to virtual machines, allows data centers to create virtual networks that span the globe while still having virtual machines be assigned globally unique identifiers. Furthermore, the physical addresses can be structured for compatibility with legacy IP protocols and current encapsulation technologies, thus reducing costs.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer system in which the principles described herein may operate.

FIG. 2 illustrates an example cloud computing environment in which the principles described herein may be employed.

FIG. 3 illustrates an example environment of a host for virtual machines.

FIG. 4 illustrates a specific example of a computing environment for sending and receiving data packets to and from virtual machines having physical addresses with a scalable address.

FIG. 5 illustrates a flowchart of a method for identifying a virtual machine and assigning a virtual address and a physical address to the virtual machine.

FIG. 6 illustrates a flowchart of a method for sending a data packet from a first virtual machine having a physical scalable address to a second virtual machine having a physical scalable address.

FIG. 7 illustrates a flowchart of a method for receiving a data packet sent from a first virtual machine having a physical scalable address with a large capacity addressing scope at a second virtual machine having a physical scalable address with a large capacity addressing scope.

FIG. 8 illustrates an example structure for a physical scalable address having a large capacity addressing scope.

### DETAILED DESCRIPTION

At least some embodiments described herein relate to assigning addresses to virtual machines. In some embodiments, a virtual machine is identified and assigned both a virtual address associated with a virtual network and a physical address. The physical address space is to be large to account for all the virtual machines belonging to all the customers that may exist in a cloud or a region of the cloud, and even perhaps in global virtual networks. By leveraging a scalable mechanism for assigning physical addresses, the virtual machines can communicate with each other seamlessly—otherwise the physical address space would have to be re-used thereby limiting the seamless connectivity amongst the virtual machines.

A data packet with a header that includes the virtual address of the virtual machine and a virtual address of a destination virtual machine is then sent from the virtual machine. An additional header that includes the physical address of the virtual machine and a physical address of the destination virtual machine is then placed on the data packet at a host of the virtual machine. The data packet is then sent from the host to a host of the destination virtual machine.

In other embodiments, a data packet that includes a header with physical addresses for both a destination virtual machine and a source virtual machine, as well as a header with a virtual address for both the destination and the source virtual machines, is received at a host of the destination virtual machine. The physical addresses for both the destination and source virtual machines are assigned using the scalable addressing mechanism that allows the physical addresses to be unique without including a machine-specific identifier that is persistently assigned to the virtual machine. The header containing the physical addresses of the source virtual machine and the destination virtual machine is then removed from the data packet and sent to the destination virtual machine.

In other embodiments, a physical address of a virtual machine that is structured to be interpretable by a computer system is created by the computer system. The physical address includes a first segment with a virtual address of the virtual machine, a second segment with an address of a host of the virtual machine, and a scalable address assigned by the scalable address mechanism and that allows the physical address to be unique without having to include in the physical address a machine-specific identifier persistently assigned to the virtual machine.

Some of the functionality gained includes the ability to create global virtual networks. With IPv4 addresses, data centers in different regions of the world have to share the same IPv4 addresses with other regions. However, utilizing the large addressing scope of IPv6 by assigning an IPv6 address to virtual machines, allows data centers to create virtual networks that span the globe. Furthermore, the physical addresses can be structured for compatibility with legacy IP protocols and current encapsulation technologies, thus reducing costs.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” or “computer system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

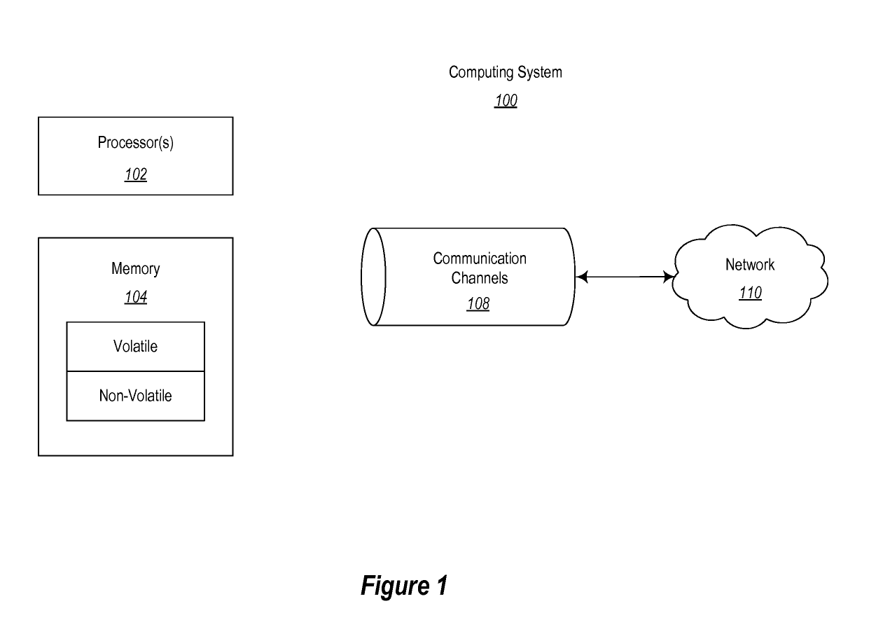

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The term “executable component” is the name for a structure that is reasonably well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable (e.g., as in the case of intermediate language component) or compiled (as in the case of a source code component) so as to generate such binary that is directly interpretable by the processors. Such an understanding of example structures of an executable component is well within the understanding of one of ordinary skill in the art of computing.

The term “executable component” is also reasonably well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is reasonable well understood by those of ordinary skill in the art of computing, whether implemented in software, hardware, or a combination.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

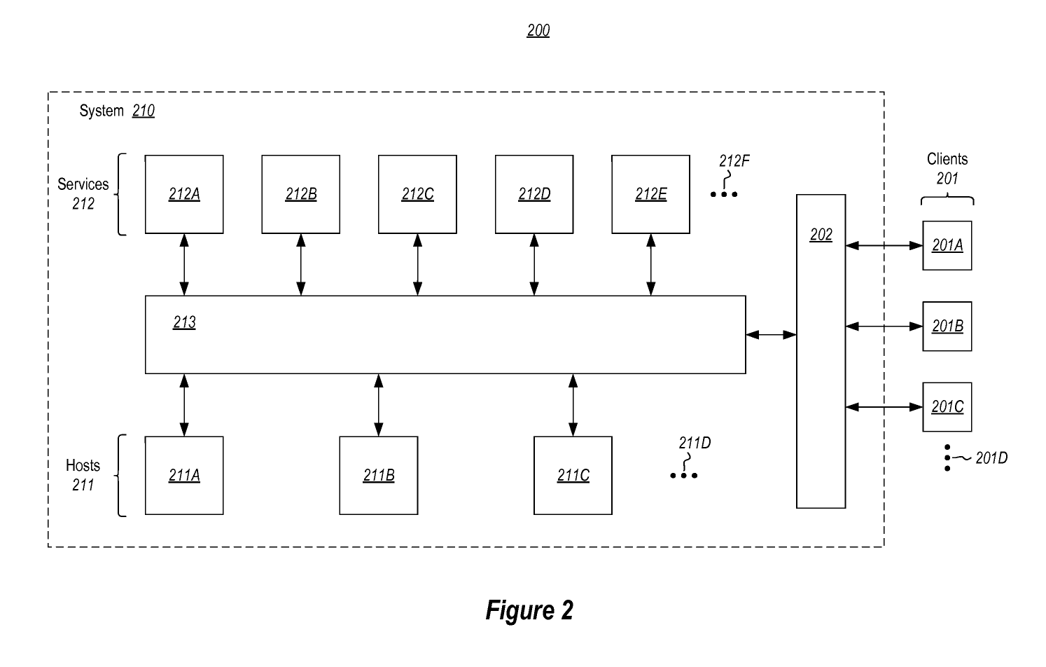

FIG. 2 abstractly illustrates an environment 200 in which the principles described herein may be employed. The environment 200 includes multiple clients 201 interacting with a system 210 using an interface 202. The environment 200 is illustrated as having three clients 201A, 201B and 201C, although the ellipses 201D represent that the principles described herein are not limited to the number of clients interfacing with the system 210 through the interface 202. The system 210 may provide services to the clients 201 on-demand and thus the number of clients 201 receiving services from the system 210 may vary over time.

Each client 201 may, for example, be structured as described above for the computing system 100 of FIG. 1. Alternatively or in addition, the client may be an application or other software executable component that interfaces with the system 210 through the interface 202. The interface 202 may be an application program interface that is defined in such a way that any computing system or software executable component that is capable of using the application program interface may communicate with the system 210.

The system 210 may be a distributed system, although not required. In one embodiment, the system 210 is a cloud computing environment. Cloud computing environments may be distributed, although not required, and may even be distributed internationally and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The system 210 includes multiple hosts 211 that are each capable of running virtual machines. Although the system 200 might include any number of hosts 211, there are three hosts 211A, 211B and 211C illustrated in FIG. 2, with the ellipses 211D representing that the principles described herein are not limited to the exact number of hosts that are within the system 210. There may be as few as one, with no upper limit. Furthermore, the number of hosts may be static, or might dynamically change over time as new hosts are added to the system 210, or as hosts are dropped from the system 210. Each of the hosts 211 may be structured as described above for the computing system 100 of FIG. 1.

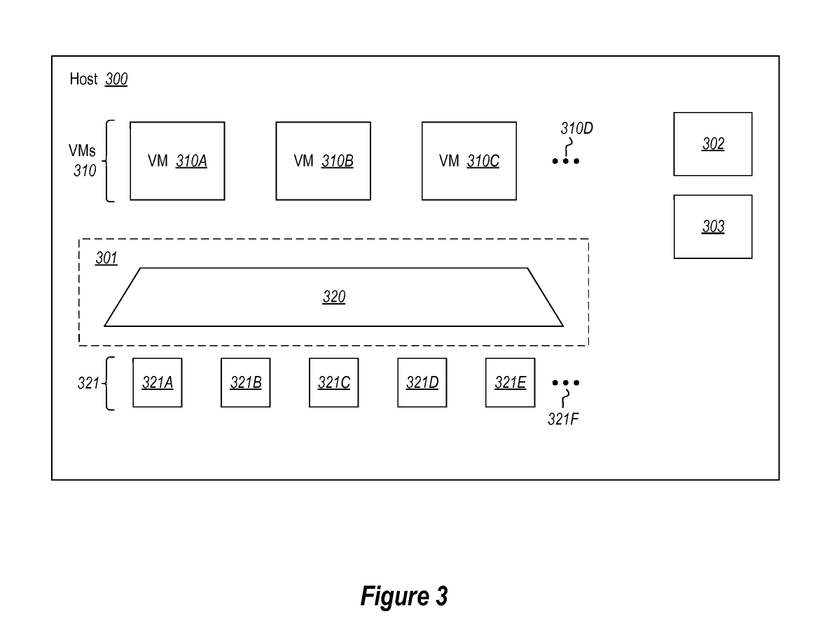

Each host is capable of running one or more, and potentially many, virtual machines. For instance, FIG. 3 abstractly illustrates a host 300 in further detail. As an example, the host 300 might represent any of the hosts 211 of FIG. 2. In the case of FIG. 3, the host 300 is illustrated as operating three virtual machines 310 including virtual machines 310A, 310B and 310C. However, the ellipses 310D once again represent that the principles described herein are not limited to the number of virtual machines running on the host 300. There may be as few as zero virtual machines running on the host with the only upper limit being defined by the physical capabilities of the host 300.

During operation, the virtual machines emulate a fully operational computing system including at least an operating system, and perhaps one or more other applications as well. Each virtual machine is assigned to a particular client, and is responsible to support the desktop environment for that client.

In one example implementation in which the virtual machine is a virtual desktop, the virtual machine generates a desktop image or other rendering instructions that represent a current state of the desktop, and then transmits the image or instructions to the client for rendering of the desktop. For instance, referring to FIGS. 2 and 3, suppose that the host 300 of FIG. 3 represents the host 211A of FIG. 2, and that the virtual machine 310A is assigned to client 201A (referred to herein as “the primary example”), the virtual machine 310A might generate the desktop image or instructions and dispatch such instructions to the corresponding client 201A from the host 211A via a service coordination system 213 and via the system interface 202.

In the virtual desktop implementation, as the user interacts with the desktop at the client, the user inputs are transmitted from the client to the virtual machine. For instance, in the primary example and referring to FIGS. 2 and 3, the user of the client 201A interacts with the desktop, and the user inputs are transmitted from the client 201 to the virtual machine 310A via the interface 201, via the service coordination system 213 and via the host 211A.

The virtual machine processes the user inputs and, if appropriate, changes the desktop state. If such change in desktop state is to cause a change in the rendered desktop, then the virtual machine alters the image or rendering instructions, if appropriate, and transmits the altered image or rendered instructions to the client computing system for appropriate rendering. From the prospective of the user, it is as though the client computing system is itself performing the desktop processing. That said, the virtual machine may emulate any computing system, regardless of whether that computing system produces a desktop, or interfaces directly with a user.

The host 300 includes a hypervisor 320 that emulates virtual resources for the virtual machines 310 using physical resources 321 that are abstracted from view of the virtual machines 310. The hypervisor 320 also provides proper isolation between the virtual machines 310. Thus, from the perspective of any given virtual machine, the hypervisor 320 provides the illusion that the virtual machine is interfacing with a physical resource, even though the virtual machine only interfaces with the appearance (e.g., a virtual resource) of a physical resource, and not with a physical resource directly. In FIG. 3, the physical resources 321 are abstractly represented as including resources 321A through 321F. Examples of physical resources 321 including processing capacity, memory, disk space, network bandwidth, media drives, and so forth.

The host 300 may operate a host agent 302 that monitors the performance of the host, and performs other operations that manage the host. Furthermore, the host 300 may include other components 303.

Referring back to FIG. 2, the system 200 also includes services 212. In the illustrated example, the services 200 include five distinct services 212A, 212B, 212C, 212D and 212E, although the ellipses 212F represent that the principles described herein are not limited to the number of service in the system 210. A service coordination system 213 communicates with the hosts 211 and with the services 212 to thereby provide services requested by the clients 201, and other services (such as authentication, billing, and so forth) that may be prerequisites for the requested service.

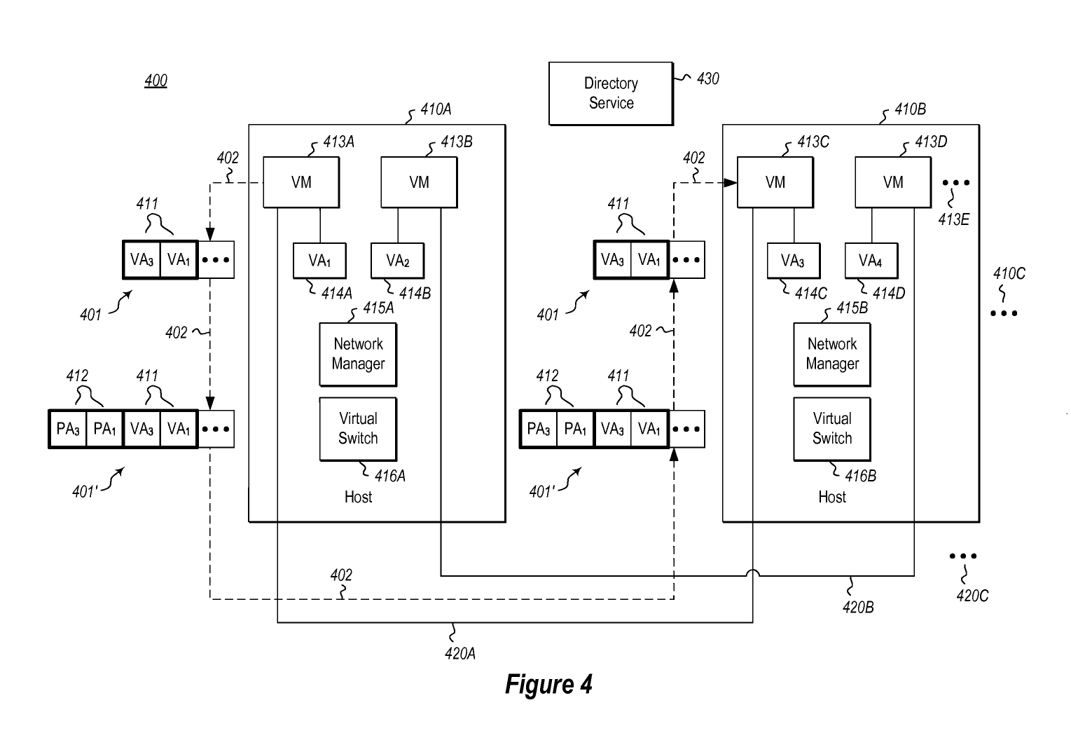

FIG. 4 illustrates a more specific example of a computing environment 400 for practicing the principles described herein. The environment 400 includes hosts, which are shown running virtual machines. For instance, the environment 400 is illustrated as including two hosts 410A and 410B, although the ellipses 410C represent that the principles described herein are not limited to the number of hosts operating with the computing environment 400. In fact, it is when the number of hosts is large that the use of high capacity address scope might fight greatest utility. As an example only, host 410A is illustrated as running two virtual machines 413A and 413B, and the host 410B is illustrated as running two virtual machines 413C and 413D, although the principles described herein are not limited to the number of virtual machines running on any given host. Again, it is when the number of possible virtual machine machines within the environment 400 is great that the use of high capacity addressing scope addresses will be of great utility to ensure uniqueness within the environment 400.

As demonstrated in FIG. 4, virtual machines running on the same host may be connected to other virtual machines running on different hosts, thus creating different virtual networks separate from the host on which a virtual machine may be running. For example, virtual machine 413A and 413B are demonstrated as running on the same host 410A. However, virtual machine 413A (along with virtual machine 413C) is connected to virtual network 420A and virtual machine 413B (along with machine 413D) is connected to virtual network 420B. Once again, ellipses 420C demonstrate that while only two virtual networks are shown in FIG. 4, any number of virtual networks may be used within the environment 400. While the virtual networks 420A and 420B are simple virtual networks having but two virtual machine end nodes, the principles described herein operate just as well for complex virtual networks having numerous nodes.

Each host 410 is also shown as including both a network manager 415 and a virtual switch 416. For instance, network manager 415A and virtual switch 416A are illustrated as operating on host 410A. Furthermore, network manager 415B and virtual switch 416B are illustrated as operating on host 410B. Although the network manager(s) 415 and virtual switch(es) 416 may run on hosts as demonstrated in FIG. 4, they may also be provided by computing resources outside of the hosts. Similarly, directory service 430 may be a separate module from any host 410 as shown in FIG. 4, or may run on host 410. Regardless of the configuration, each host may have an associated network manager, virtual switch and directory service at its disposal, each of which are examples of the executable component described above.

Each time a new virtual machine 413 is created, network manager 415 identifies the existence of the virtual machine and subsequently assigns both a virtual address 414 and a physical address to that virtual machine. For instance, the network manager 415A may assign virtual address 414A (VA₁) to virtual machine 413A, and virtual address 414B (VA₂) to virtual machine 413B. Likewise, For instance, the network manager 415B may assign virtual address 414C (VA₃) to virtual machine 413C, and virtual address 414D (VA₄) to virtual machine 413D.

The virtual address assigned to a virtual machine may be unique within the virtual machine's virtual network, while the physical address may be globally unique. In some embodiments, virtual machine 413 may even be unaware of the physical address that the virtual machine has been assigned by network manager 415. Notably, the virtual and physical addresses assigned to a particular virtual machine may follow any applicable Internet standard, including IP protocol standards (e.g., IPv4 protocol, IPv6 protocol, MAC addresses).

Once the network manager 415 has assigned an address (whether virtual, physical or both) to a virtual machine, the network manager informs directory service 430 of that assignment. The network manager may continually update the directory service with the status of each virtual machine currently running on the host with which the network manager is associated. For example, network manager 415A may continually update directory service 430 with information regarding virtual machine 413A (such as the host identity, the virtual address, and/or the physical address of virtual machine 413A). Directory service 430 may then store a mapping of virtual machine 413A to that virtual machine's corresponding virtual address 414A, physical address, and host 410A.

The mappings stored in directory service 430 are then readily accessible for network management by network manager 415, and for routing by virtual switch 416. Virtual switch 416 is responsible for routing data sent to and from the virtual machines running on the host with which the virtual switch is associated. As described in more detail hereinafter, when a data packet is sent from a virtual machine, the data packet includes a header 411 containing the virtual addresses assigned to both the virtual machine that sent the data packet (the “source virtual machine”) and the virtual machine that is to receive the data packet (the “destination virtual machine”). The header, however, may not initially include the physical addresses assigned to the source and destination virtual machines. In such cases, virtual switch 416 may then place an additional header 412 on the data packet including the physical addresses of the source and destination virtual machines before routing the data packet to the destination virtual machine.

In some embodiments, the additional header containing the physical addresses may be placed on the data packet after virtual switch 416 has communicated directly with directory service 430 to determine a destination of the data packet. In other embodiments, the network manager may place the additional header on any outgoing data packets. In yet other embodiments, Network manager 415 may act as an intermediary between the virtual switch 416 and the directory service 430 by programming the virtual switch using the mappings stored in the directory service.

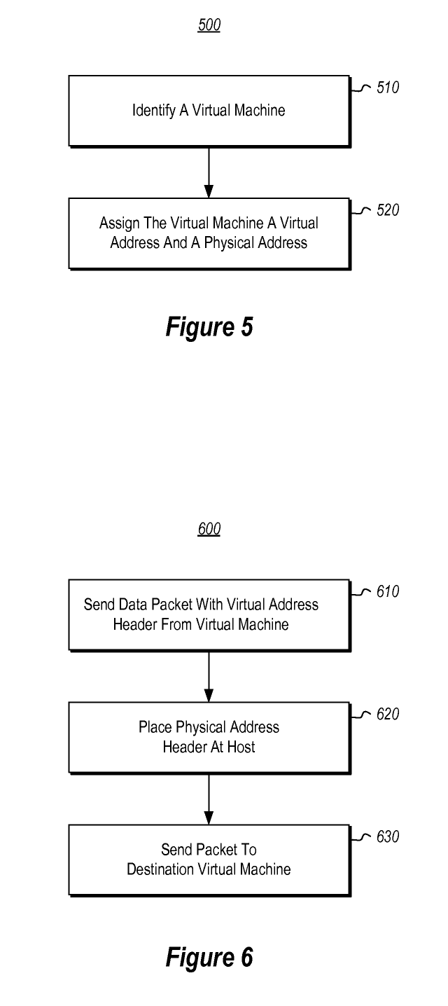

As the methods described in the flow charts of FIGS. 5, 6 and 7 may be performed in the environment 400, those methods will be described with frequent reference to FIG. 4. Furthermore, to illustrate the principles described herein, a particular scenario will now be outlined and used throughout the description of FIGS. 5 through 7. In this scenario, two separate customers (customer1 and customer2) each request a cloud computing service to provide two virtual machines that create a virtual network. In this scenario, while the cloud computing service provides each customer with the two requested virtual machines, neither customer's virtual machines are running on the same host. In other words, each customer has one virtual machine running on one host and a second virtual machine running on a second, different host. For example, customer1 may have been provided virtual machine 413A running on host 410A and virtual machine 413C running on host 410B, thus creating virtual network 420A. On the other hand, customer2 may have been provided virtual machine 413B running on host 410A and virtual machine 413D running on host 410B, thus creating virtual network 420B.

FIG. 5 illustrates a flow chart of an example method 500 for identifying a virtual machine and assigning both a virtual address and a physical address to that virtual machine. The method 500 begins when the cloud computing service has fulfilled at least one of the customer's requests, thus creating a new virtual machine 413, which is identified by network manager 415 (act 510).

As part of the identification, network manager 415 may identify the host of the virtual machine, as well as whether or not the virtual machine has been assigned either a virtual or physical address. Network controller 415 may then communicate that information to directory service 430, thus allowing directory service 430 to create a mapping for virtual machine 413 to its associated information (e.g., host, assigned virtual address, assigned physical address). For example, when virtual machine 413A is created and provided to customer1, network controller 415A may identify that virtual machine 413A is running on host 410A and has not yet been assigned either a virtual or physical address. Network controller 415A may then communicate that information to directory service 430, which can then create a mapping of the information.

After identifying newly created virtual machine 413A and verifying that the virtual machine has not been assigned a virtual or physical address, network controller 415A may assign the virtual machine both a virtual address 414 associated with a virtual network 420 and a physical address with a large capacity physical addressing scope (act 520). Virtual address 414A may be completely unique within virtual network 420A and is used to identify virtual machine 413A within virtual network 420A. As described herein, both virtual address 414A and the assigned physical address may follow any applicable Internet standard, including IP protocol standards IPv4 and IPv6, as well as MAC address standards.

As described herein, the physical address assigned may have a large capacity addressing scope, such as IPv6. Because the IPv6 standard includes an addressing scope of 128 bits, using an IPv6 addressing space may allow the physical address to be a globally unique identifier for the virtual machine to which it is assigned. Furthermore, using IPv6 for the physical address may obviate the need to assign MAC addresses to individual virtual machines in order to have completely unique identifiers for all virtual machines.

Conversely, using a low capacity addressing space associated with the physical address would be perhaps be insufficient to uniquely identify the virtual machine. In some embodiments the low capacity physical addressing space comprises 32 bits. In other embodiments, the low capacity physical addressing space comprises less than 32 bits.

In some embodiments, both the virtual address and the physical address may be defined and utilized at the same layer of the OSI or TCP/IP Models. For example, the virtual address may be an IPv4 address and the physical address may be an IPv6 address, thus using addressing protocols for the virtual and physical addresses that are both defined and utilized in the Network Layer of the OSI Model and the Internet Layer of the TCP/IP Model.

Once the virtual machine has been identified and assigned both a virtual address and a physical address by the network manager, the network manager may update the directory service 430 with that new information. For example, after assigning virtual machine 413A virtual address 414A and a physical address, network controller 415A may communicate to directory service 430 that virtual machine 413A has been assigned both a virtual and physical address. Subsequently, directory service 430 may update its mapping of virtual machine 413A with its newly assigned virtual address 414A and physical address.

FIG. 6 illustrates a flowchart of a method 600 for sending a data packet from a first virtual machine having a physical address with a large capacity addressing scope to a second virtual machine having a physical address with a large capacity addressing scope. The method 600 may begin when virtual machine 413A attempts to communicate with virtual machine 413C by sending a data packet 401 to virtual machine 413C (act 610) along a path represented by dashed-lined arrows 402. When sent, the data packet 401 may include the virtual addresses assigned to virtual machine 413A and virtual machine 413C, as demonstrated in FIG. 4.

Once the data packet 411 has been sent from virtual machine 413A, virtual switch 416A may communicate with directory service 430 to perform a look-up of the mappings associated with the source virtual machine 413A and destination virtual machine 413C. The look-up may inform the virtual switch of the host, assigned virtual address and assigned physical address of both the source and destination virtual machines. For example, virtual switch 416A may perform the look-up and discover that destination virtual machine 413C is running on host 410B and has been assigned virtual address 414C and a particular physical address based on a mapping stored at directory service 430.

Virtual switch 416 may then place an additional header 412 on the data packet 401 including the physical address of virtual machine 413A and the physical address of virtual machine 413C at host 410A (act 620), to thereby form data packet 401′. In some embodiments, however, network manager 415A may place the additional header 412 on the data packet.

In some embodiments, the additional header may encapsulate an IPv4 data packet inside an IPv6 data packet. In such cases, the encapsulated data packets may still be transmitted over an IPv4 network, if necessary, using any standard Internet transition mechanisms such as 6to4, Teredo, and Isatap. Regardless of any necessary encapsulation, once the additional header 412 has been placed, virtual switch 416A then sends the data packet 401′ from host 410A to host 410B (act 630).

It should be noted that while the example used throughout refers to two virtual machines on the same virtual network, these same steps may also be used in circumstances where two or more virtual machines that are not on the same virtual network are in communication. Furthermore, in instances where the cloud computing service provider may need to perform maintenance on, or communicate with, one of its virtual machines, similar steps may also be taken. In such circumstances, once virtual machine 413 has sent a data packet with a header containing its virtual address 414, virtual switch 416 will place an additional header with the large capacity physical address assigned to virtual machine 413 and then route the data packet to a server of the cloud computing service provider.

Similarly, when host 415 receives (such as a data packet 401′) from a server of the cloud computing service provider with an additional header that includes the large capacity physical address assigned to the intended destination virtual machine 413, virtual switch 416 may remove the additional header to restore the packet 401, and route the data packet 401 that still contains the virtual address of the destination virtual machine to the destination virtual machine. In this way, large capacity physical addresses may be used to uniquely identify virtual machines globally in communications between virtual machines, as well as between virtual and physical machines.

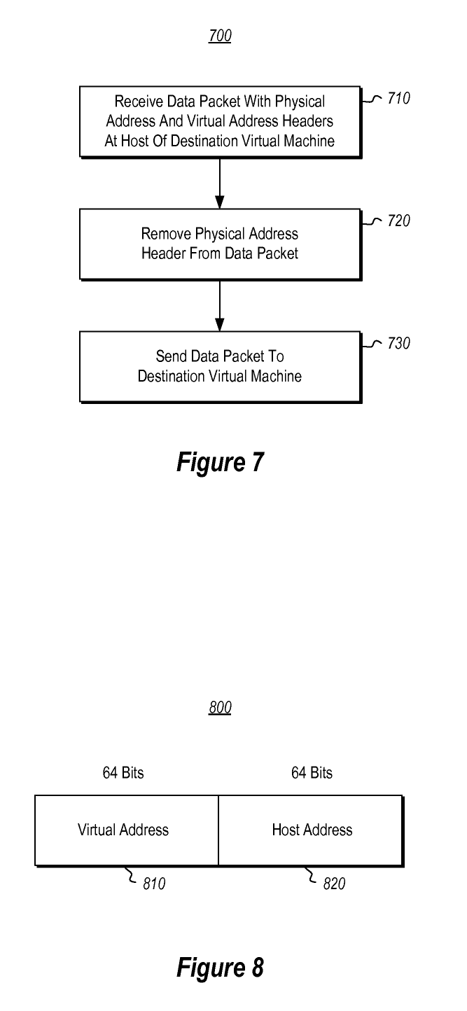

FIG. 7 illustrates a flow chart of a method 700 for receiving a data packet sent from a first virtual machine having a physical address with a large capacity addressing scope at a second virtual machine having a physical address with a large capacity addressing scope. The data packet 401′ with additional header 412 that includes large capacity physical addresses for both virtual machine 413A (source virtual machine) and virtual machine 413C (destination virtual machine) is then received at host 410B (act 710).

Once the data packet 401′ with the additional header 412 is received at host 410B, the additional header 412 is removed, leaving header 411, and restoring the packet 401, which includes the virtual addresses of the source virtual machine 413A and the destination virtual machine 413C. Header 412 may be removed by virtual switch 416B of host 410B. In other embodiments, header 412 may be removed by network manager 415B of host 410B. After removing header 412, the data packet 401 including header 411 may then be sent to virtual machine 413C by virtual switch 416B. This completes the communication of packet 401 along the path 402 of FIG. 4.

FIG. 8 illustrates an example structure for a physical address having a large capacity addressing scope. Physical address 800 may be structured in a variety of ways, including using an IPv6 address (i.e., 128 bits) that includes two 64-bit segments. In such cases, the first segment may comprise the virtual address of the virtual machine to which physical address 800 has been assigned and the second segment may comprise an address assigned to the host of the virtual machine to which physical address 800 has been assigned. Alternatively or in addition, the second segment may comprises a virtual network identifier, and/or a customer identifier.

For example, referring again to FIG. 4, the physical address of virtual machine 413A may include a first 64-bit segment that comprises virtual address 414A, which virtual address has been assigned to virtual machine 413A. Furthermore, the physical address of virtual machine 413A may include a second 64-bit segment that comprises an address assigned to host 410A. As such, virtual address 414A and the address assigned to host 410A may comprise an IPv4 address (32 bits), a MAC address (48 bits) or any other address protocol that uses 64 bits or less.

As described herein, using a 128-bit physical address assigned to a virtual machine, like IPv6 for example, may allow physical address 800 to be globally unique without having to use a machine-specific identifier that is persistently assigned to the virtual machine. Furthermore, the large addressing scope may allow for structuring the physical address such that it may contain legacy protocols, making it compatible with already existing technologies (e.g., IPv4, MAC addresses).

For instance, assigning both virtual address 414A (even if using a 32-bit IPv4 address) and 128-bit physical address 800 to virtual machine 413A may allow virtual machine 413A to be uniquely addressed both within virtual network 420A and globally, without having to assign a MAC address to virtual machine 413A. However, in some embodiments, physical address 800 may not be globally unique.

As discussed herein, physical address 800 may be structured in a variety of ways. For example, physical address 800 may be structured such that it is compatible with current protocols such as IPv4, IPv6 and MAC addresses, among others. In some embodiments, the large capacity physical addressing scope associated with physical address 800 comprises more than 32 bits. In other embodiments, the large capacity physical addressing scope associated with physical address 800 comprises at least 64 bits. In yet other embodiments, the large capacity physical addressing scope associated with physical address 800 comprises 128 bits, as in the case of FIG. 8.

In this way, large capacity physical addresses may be used to uniquely identify virtual machines globally in communications between virtual machines, as well as communications between virtual and physical machines. Furthermore, these large capacity physical addresses may be structured to comply with already existing technologies, thus reducing costs.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system, comprising:
one or more processors; and
one or more storage devices having stored thereon computer-executable instructions that are executable by the one or more processors to configure the system to assign a physical address with a large capacity physical addressing scope to a virtual machine, including instructions that are executable to configure the computer system to perform at least the following:
identify a virtual machine;
assign the virtual machine a virtual address associated with a virtual network and a physical address associated with a large capacity physical addressing scope, the large capacity physical addressing scope allowing the physical address to be unique without including a machine-specific identifier persistently assigned to the virtual machine, whereas a low capacity physical addressing space would be insufficient to uniquely identify the virtual machine using an associated physical address;
send a data packet from the virtual machine, the data packet comprising a header that includes the virtual address of the virtual machine and a virtual address of a destination virtual machine;
place an additional header on the data packet at a host of the virtual machine, the additional header comprising the physical address of the virtual machine and a physical address of the destination virtual machine; and
send the data packet from the host to a host of the destination virtual machine.

2. The computer system in accordance with claim 1, wherein the physical address of the virtual machine comprises an IPv6 address.

3. The computer system in accordance with claim 1, wherein the large capacity physical addressing scope comprises more than 32 bits.

4. The computer system in accordance with claim 1, wherein the large capacity physical addressing scope comprises at least 64 bits.

5. The computer system in accordance with claim 1, wherein the large capacity physical addressing scope comprises 128 bits.

6. The computer system in accordance with claim 1, wherein the low capacity physical addressing space comprises 32 bits.

7. The computer system in accordance with claim 1, wherein the low capacity physical addressing space comprises less than 32 bits.

8. The computer system in accordance with claim 1, wherein the virtual address and the physical address are defined and utilized at a network layer of an OSI Model.

9. The computer system in accordance with claim 1, wherein the computer executable instructions further configure the computer system with a network manager assigns the virtual address and the physical address to the virtual machine.

10. The computer system in accordance with claim 1, wherein the computer executable instructions further configure the computer system with a directory service that stores a mapping of the virtual machine to the virtual machine's corresponding virtual address, physical address, and host.

11. The computer system in accordance with claim 10, wherein the computer executable instructions further configure the network manager to provide the directory service with the mapping.

12. The computer system in accordance with claim 10, wherein the computer executable instructions further configure a virtual switch of the host to place the additional header on the data packet after the virtual switch has communicated with the directory service to determine a destination of the data packet.

13. The computer system in accordance with claim 1, wherein the additional header encapsulates an IPv4 data packet inside an IPv6 data packet.

14. A computer program product comprising one or more hardware storage devices having stored thereon computer-executable instructions that are executable by one or more processors of a computer system to configure the computer system to assign a physical address with a large capacity physical addressing scope to a virtual machine, including computer-executable instructions that configure the computer system to perform at least the following:
receive a data packet at a host of a destination virtual machine, the data packet comprising at least two headers, a first header containing a physical address of a source virtual machine and a physical address of the destination virtual machine, the physical addresses associated with a large capacity physical addressing scope, and a second header comprising a virtual address of the source virtual machine and a virtual address of the destination virtual machine, the large capacity physical addressing scope allowing the physical address to be unique without including a machine-specific identifier persistently assigned to the virtual machine, whereas a low capacity physical addressing space would be insufficient to uniquely identify the virtual machine using an associated physical address;
remove the header comprising the physical addresses of both the source virtual machine and the destination virtual machine from the data packet; and
send the data packet to the destination virtual machine.

15. The computer program product in accordance with claim 14, wherein the physical address of the virtual machine is not unique.

16. The computer program product in accordance with claim 14, wherein the physical address of the virtual machine is globally unique.

17. The computer program product in accordance with claim 14, wherein the virtual address of the source virtual machine comprises an IPv6 address.

18. The computer program product in accordance with claim 14, wherein the virtual address of the source virtual machine comprises an IPv4 address.

19. The computer program product in accordance with claim 14, wherein the header comprising the physical addresses is removed by a virtual switch of the host of the destination virtual machine.

20. A computer program product comprising one or more hardware storage devices having stored thereon computer-executable instructions that are executable by one or more processors of a computer system to configure the computer system to perform at least the following:
create a physical address of a virtual machine structured to be interpretable by the computer system, the physical address including a first segment comprising a virtual address of the virtual machine and a second segment comprising at least one of an address of a host of the virtual machine, a virtual network identifier, and a customer identifier, the physical address having a large capacity addressing scope that allows the physical address to be unique without having to include with the physical address a machine-specific identifier persistently assigned to the virtual machine.
